(19) United States
(12) Patent Application Publication
(10) Pub. No.: US 2009/0135892 A1
(43) Pub. Date: May 28, 2009

(54) APPARATUS AND METHOD FOR MEASURING CARRIER-TO-INTERFERENCE-AND-NOISE RATIO OF LOGICAL BAND USING DOWNLINK PREAMBLE

(75) Inventor: Ki Young KWAK, Seongnam-si (KR)

Correspondence Address: BLANK ROME LLP, WATERGATE, 600 NEW HAMPSHIRE AVENUE, N.W., WASHINGTON, DC, 20037, US

(73) Assignee: Posdata Co., Ltd.

(21) Appl. No.: 12/159,713

(22) PCT Filed: Dec. 27, 2006
(86) PCT No.: PCT/KR2006/005771

§ 371 Date: Jun. 30, 2008

(30) Foreign Application Priority Data
Dec. 31, 2005 (KR) 10-2005-0136249

(51) Int. Cl. H04B 17/00

(52) U.S. Cl. 375/227

(57) ABSTRACT

Provided are an apparatus and method for measuring a carrier-to-interference-and-noise ratio (CINR) using down-link preambles. More particularly, provided are an apparatus and method that measure CINRs according to a plurality of logical bands in a downlink band-adaptive modulation and coding (AMC) channel mode zone using preambles and determine whether or not to switch to another channel mode or logical band on the basis of the CINRS. According to the apparatus and method, it is possible to easily measure a plurality of CINRs and switch to a better channel mode or another logical band using the measured CINRs. Consequently, the optimum channel environment can be maintained.

### TECHNICAL FIELD

The present invention relates to an apparatus and method for measuring carrier-to-interference-and-noise ratios (CINRs) of logical bands using downlink preambles. More particularly, the present invention relates to an apparatus and method that measure CINRs according to a plurality of logical bands in a downlink band-adaptive modulation and coding (AMC) channel mode zone using preambles and determine whether or not to switch to another channel mode or logical band on the basis of the CINRs.

### BACKGROUND ART

When a signal is transmitted through a multipath channel, inter-symbol interference (ISI) due to multipaths occurs in the received signal. In order to reduce signal distortion caused by ISI, a symbol period must be longer than a channel delay spread. As a modulation method capable of simply compensating for such distortion occurring in a multipath channel, an orthogonal frequency division multiplexing (OFDM) technique (or an orthogonal frequency division multiple access (OFDMA) technique) has been suggested. Unlike a transmission technique using a single carrier, the OFDM technique transfers data using a plurality of mutually orthogonal sub-carriers. More specifically, the OFDM technique performs serial-parallel conversion of input data as many times as the number of sub-carriers used for modulation and modulates each converted data using the corresponding sub-carriers, thereby increasing the symbol period of each sub-carrier by the number of sub-carriers while maintaining a data transfer rate as is. Since the OFDM technique uses mutually orthogonal sub-carriers, it has better bandwidth efficiency and a longer symbol period than a conventional frequency division multiplexing (FDM) technique. Thus, the OFDM technique is more resistant to ISI than a single carrier modulation technique.

In an OFDM system, a transceiver unit performs a modulation/demodulation process of inverse discrete Fourier transform (IDFT) and discrete Fourier transform (DFT), which can be efficiently implemented by inverse fast Fourier transform (IFFT) and fast Fourier transform (FFT). Here, when a longer guard interval than a channel delay spread is inserted into each transmitted symbol period, sub-carrier orthogonality is maintained.

In the above-described OFDM system, accurate measurement of channel signal quality is of utmost important for power control or modulation/demodulation. A carrier-to-interference-and-noise ratio (CINR) is a quantity used to gauge channel quality, and is used to control power and adjust a modulation and coding scheme (MCS) level according to channel quality in an apparatus for adaptive power control or adaptive modulation and coding scheme (MCS). Here, the CINR is defined as total sub-carrier signal power divided by total noise and interference power, and can be a reference for determining channel quality in the OFDM system.

Meanwhile, the Institute of Electrical and Electronics Engineers (IEEE) 802.16d/e standards divide one frame of a downlink (DL) sub frame and an uplink (UL) subframe into a plurality of uniform sections and support multiple zones using different channel modes respectively for the sections. In a multiple-zone environment, a plurality of channel modes exist. Herein, in the OFDM/OFDMA frame with multiple zones, a plurality of permutation zones such as PUSC, FUSC, PUSC with all sub-channel, and etc. exist. Since the channel modes occupy different frequency bands or permutation zones occupy different time domain, their channel environments may not be uniform. In addition, a band-adaptive modulation and coding (AMC) zone conforming to the IEEE 802.16d/e standards includes a plurality of logical bands, which likewise show difference in channel environments due to difference in frequency bands.

Therefore, it is required to extract predetermined channel quality information from each of a plurality of logical bands, switch to a better channel mode or another logical band on the basis of the information, and thereby provide a user with a better channel environment.

Consequently, the present invention suggests a new technology relating to an apparatus and method for measuring CINRs of a plurality of logical bands using preambles of a received signal in a digital communication system.

### DISCLOSURE OF INVENTION

### Technical Problem

The present invention is directed to more easily and accurately measuring carrier-to-interference-and-noise ratios (CINRs) for each logical band using preambles.

The present invention is also directed to determining whether or not to switch to a better channel mode (permutation zone) or another logical band on the basis of CINRs respectively measured according to logical bands.

The present invention is also directed to more accurately estimating a preamble signal from a preamble symbol by an interpolation operation and an averaging operation.

The present invention is also directed to selectively extracting noise and interference component signals according to a frequency reuse factor and thereby measuring a CINR more accurately.

The present invention is also directed to reporting a CINR measured by a communication terminal to the corresponding base station and allowing the base station to recognize the channel state, etc. of the communication terminal and use them for scheduling.

### Technical Solution

One aspect of the present invention provides an apparatus for measuring carrier-to-interference-and-noise ratios (CINRs) in a downlink channel mode zone having a plurality of logical bands, the apparatus comprising: a preamble symbol obtaining unit for obtaining downlink preamble symbols from a baseband frequency signal; a signal estimation unit for estimating preamble signals and data signals from the preamble symbols; a power calculation unit for calculating power values of the estimated data signals and calculating power values of noise signals from the preamble symbols and the estimated preamble signals; and a CINR calculation unit for calculating CINRs using the power values of the data signals and the noise signals.

Another aspect of the present invention provides a method of measuring CINRs in a downlink channel mode zone having a plurality of logical bands, the method comprising the steps of: obtaining downlink preamble symbols from a baseband frequency signal; estimating preamble signals and data signals from the preamble symbols; calculating power values of the estimated data signals and calculating power values of noise signals from the preamble symbols and the estimated preamble signals; and calculating CINRs using the power values of the data signals and the noise signals.

### ADVANTAGEOUS EFFECTS

According to the present invention, carrier-to-interference-and-noise ratios (CINRs) are more easily and accurately measured according to a plurality of logical bands using preambles.

In addition, according to the present invention, it is possible to determine whether or not to switch to a better channel mode or another logical band on the basis of CINRs respectively measured according to a plurality of logical bands.

In addition, according to the present invention, a preamble signal can be estimated from a preamble symbol more accurately by an interpolation operation and an averaging operation.

In addition, according to the present invention, noise and interference component signals are selectively extracted according to a frequency reuse factor, so that a CINR can be measured more accurately.

In addition, according to the present invention, a CINR measured by a communication terminal is reported to the corresponding base station, so that the base station can recognize the channel state, etc. of the communication terminal and use them for scheduling.

### BRIEF DESCRIPTION OF THE DRAWINGS

FIG. 1 is a block diagram showing a constitution of a general orthogonal frequency division multiplexing (OFDM) system;

FIG. 2 illustrates a structure of a plurality of channel modes according to an exemplary embodiment of the present invention;

FIG. 3 illustrates preamble structures according to segment in an exemplary embodiment of the present invention;

FIG. 4 is a block diagram of an apparatus for measuring logical band-specific carrier-to-interference-and-noise ratios (CINRs) according to an exemplary embodiment of the present invention;

FIG. 5 is a block diagram showing a constitution of an apparatus for measuring a CINR according to an exemplary embodiment of the present invention;

FIG. 6 is a block diagram showing a constitution of a signal estimation unit according to an exemplary embodiment of the present invention;

FIG. 7 is a block diagram showing a constitution of a power calculation unit according to an exemplary embodiment of the present invention;

FIG. 8 is a block diagram showing a constitution of a power calculation unit based on preamble according to an exemplary embodiment of the present invention;

FIG. 9 is a block diagram showing a constitution of a CINR calculation unit according to an exemplary embodiment of the present invention; and

FIG. 10 is a flowchart showing a method of measuring CINRs using preambles according to an exemplary embodiment of the present invention.

### MODE FOR THE INVENTION

In this specification, the terminology “communication terminal” refers to a portable electric/electronic device, including all kinds of handheld wireless communication devices such as equipment having communication functions, portable terminals, and international mobile telecommunication (IMT)-2000 terminals. The equipment having communication functions includes personal digital cellular (PDC) phones, personal communication service (PCS) phones, personal handyphone system (PHS) phones, code division multiple access (CDMA)-2000 (1× and 3×) phones, wideband CDMA (WCDMA) phones, dual band/dual mode phones, global standard for mobile (GSM) phones, mobile broadband system (MBS) phones, digital multimedia broadcasting (DMB) terminals, smart phones, orthogonal frequency division multiplexing (OFDM)/orthogonal frequency division multiple access (OFDMA) communication terminals, and so on. The portable terminals include personal digital assistants (PDAs), hand-held personal computers (PCs), notebook computers, laptop computers, wireless broadband Internet (WiBro) terminals, moving picture experts group layer 3 (MP3) players, mini disc (MD) players, and so on. And, the IMT-2000 terminals provide an international roaming service and an expanded mobile communication service. A communication terminal may have a predetermined communication module such as an OFDMA module, a CDMA module, a Bluetooth module, an infrared communication module, a wired/wireless local area network (LAN) card, and a wireless communication device equipped with a global positioning system (GPS) chip to enable positioning using a GPS system. Also, a communication terminal is equipped with a microprocessor capable of playing multimedia, thereby performing a specific operation.

In addition, the terminology “noise” (or “noise signal”) includes interference between channels occurring when frequency bands overlap each other and signals are mixed with each other as well as non-intended abnormal noise generated in a wireless communication environment. Noise includes not only a data signal intended to be transmitted but also all other signals included during a transmitting/receiving process. Therefore, in the present invention, “noise” and “noise and interference” may be considered as the same thing.

Hereinafter, an apparatus and method for measuring carrier-to-interference-and-noise ratios (CINRs) using downlink preambles (referred to as “preambles” below) according to exemplary embodiments of the present invention will be described in detail with reference to the appended drawings.

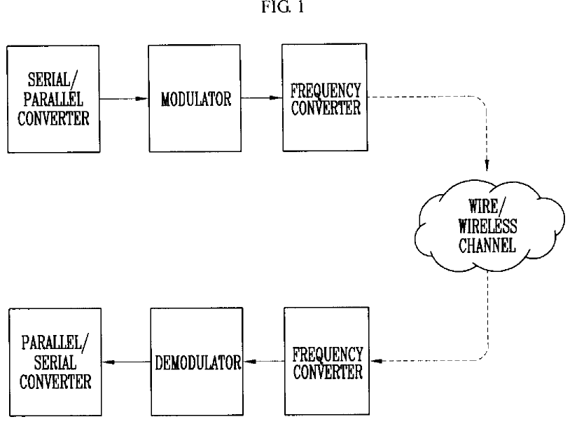

FIG. 1 is a block diagram showing a constitution of a general OFDM system. As illustrated in FIG. 1, the general OFDM system includes a serial/parallel converter, a fast Fourier transform (FFT) device or inverse fast Fourier transform (IFFT) device, and a frequency converter.

The serial/parallel converter of a transmitting unit converts a data stream input in serial into parallel data streams numbering the same as sub-carriers, and the IFFT device performs an IFFT operation on each parallel data stream. The IFFT data is converted back into serial data, and transmitted after frequency conversion. A receiving unit receives a signal transmitted through a wired/wireless channel, and outputs data after a demodulation process that is the reverse of a process performed by the transmitting unit.

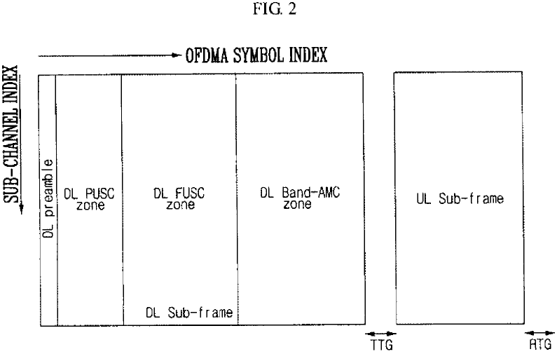

FIG. 2 illustrates a structure of a plurality of channel modes according to an exemplary embodiment of the present invention. In general, according to the Institute of Electrical and Electronics Engineers (IEEE) 802.16d/e standards, a downlink (DL) sub frame 1 and an uplink (UL) sub frame both support multiple zones. As illustrated in FIG. 2, in a sub-frame structure having multiple zones of a DL channel, one DL sub-frame is divided into predetermined sections, i.e., the multiple zones, and the sections use different channel modes, respectively. Herein, the channel modes are permutation zone such as partial usage of sub-channels (PUSC), full usage of sub-channels (FUSC), Band-AMC and etc. In addition, DL partial usage of sub-channels (PUSC), DL full usage of sub-channels (FUSC) and DL band-adaptive modulation and coding (AMC) may be used as channel modes in a DL. The band-AMC channel mode includes a plurality of logical bands and variably allocates them to a user (terminal).

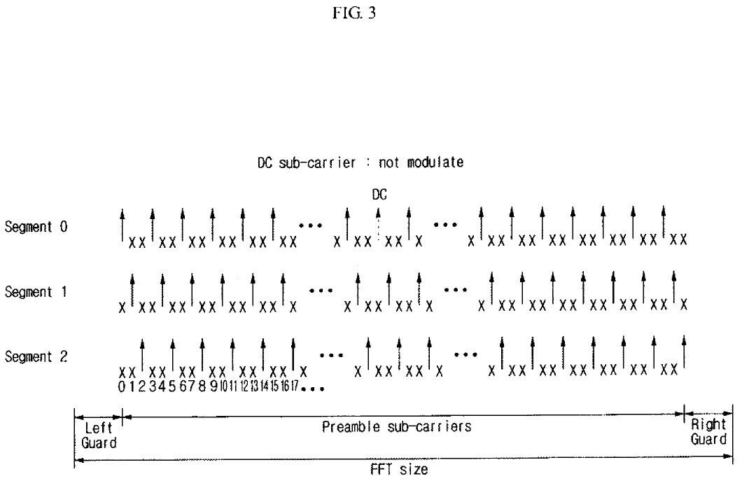

FIG. 3 illustrates preamble structure according to segment in an exemplary embodiment of the present invention. As illustrated in FIG. 3, guard bands for reducing interference from adjacent frequency bands are placed on the left and right of a plurality of sub-carriers, and a direct current (DC) sub-carrier, which is a null sub-carrier, is placed. In addition, preamble sub-carriers are located at predetermined intervals in a segment. As illustrated in FIG. 3, every third sub-carrier is a preamble sub-carrier and may be used for initial synchronization, cell search, frequency offset and channel estimation.

In general, a preamble signal has a higher signal level than a data signal and a pilot signal, and thus can be easily obtained even in a poor channel environment. Therefore, the present invention uses such preamble signals to measure a CINR, thereby improving accuracy. Here, when CINRs are measured according to a plurality of logical bands, pilot signals are not efficient because the number of pilot signals (amount of information) is not enough to correspond to all the logical bands.

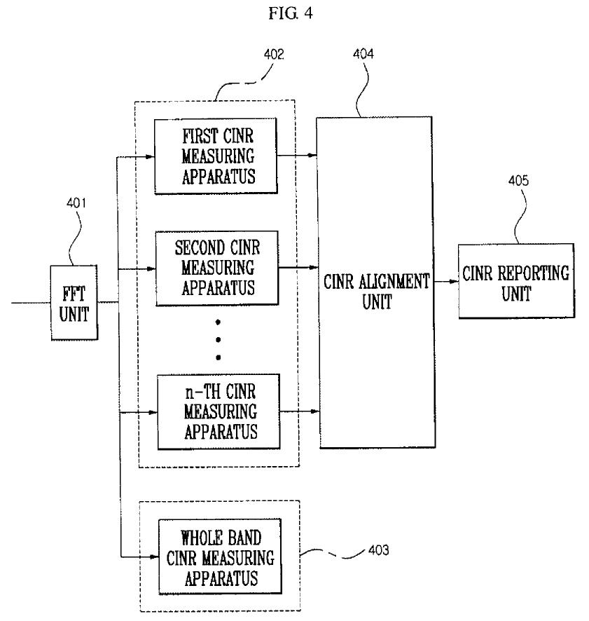

FIG. 4 is a block diagram of an apparatus for measuring logical band-specific CINRs according to an exemplary embodiment of the present invention. As illustrated in FIG. 4, in order to measure CINRs according to logical bands using preambles, an FFT unit 401 performs FFT on preambles received from the time domain in the baseband.

The FFT-processed preambles are classified into sub-groups the same as the logical bands, and logical band-specific CINR measuring apparatuses 402 measure CINRs of the corresponding sub-groups according to the logical bands.

In addition, according to the present invention, a whole band CINR measuring apparatus 403 for measuring a reference CINR using preambles of the entire frequency domain is further included.

A CINR alignment unit 404 receives a plurality of CINRs respectively measured according to the logical bands, aligns them in decreasing order, and selects as many CINRs as a number required for the corresponding base station. The CINRs selected in this way are mapped into a format determined for a CINR reporting unit 405 to report them to the base station.

The CINR measuring apparatuses 402 of the present invention can be implemented in digital communication systems such as communication terminals, and the digital communication systems may be based on at least one of the IEEE 802.16d/e, wireless broadband Internet (WiBro), and worldwide interoperability for microwave access (WiMAX) standards.

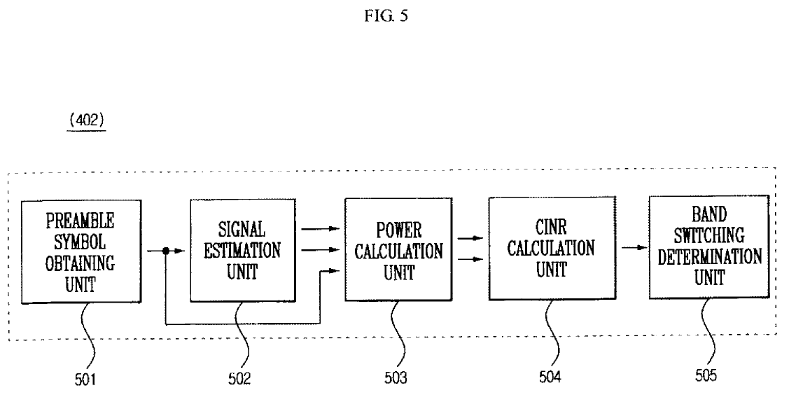

FIG. 5 is a block diagram showing a constitution of the CINR measuring apparatus 402 according to an exemplary embodiment of the present invention.

As illustrated in FIG. 5, the CINR measuring apparatus 402 includes a preamble symbol obtaining unit 501, a signal estimation unit 502, a power calculation unit 503, a CINR calculation unit 504, and a band switching determination unit 505. The preamble symbol obtaining unit 501 obtains preamble symbols (or preamble symbol signal) from a baseband frequency signal. As an example of the present invention, the preamble symbol obtaining unit 501 multiplies a preamble code by a plurality of sub-carriers of the baseband frequency signal, which is an OFDM/OFDMA signal, or performs an exclusive OR (XOR) operation on them, thereby obtaining preamble symbols to be used for measuring a CINR.

The transmission positions of preamble symbols have been regulated according to each channel mode, and preamble symbols have orthogonality. Therefore, preamble symbols can be easily extracted by multiplying sub-carriers of a received signal by a preamble sequence (code) having a regulated uniform pattern. A preamble code is a unique value determined for each cell or sector and is transmitted from a base station managing the cell or sector to a terminal.

For example, when a preamble signal having a previously set uniform pattern is modulated using binary phase shift keying (BPSK), a preamble sequence corresponds to 1 and −1 of a complex number because a transmission signal is made to correspond to two phases, i.e., 0 and π and transmitted by BPSK. Therefore, only the desired preamble symbols can be obtained by calculating correlation between the preamble sequence and the received baseband signal.

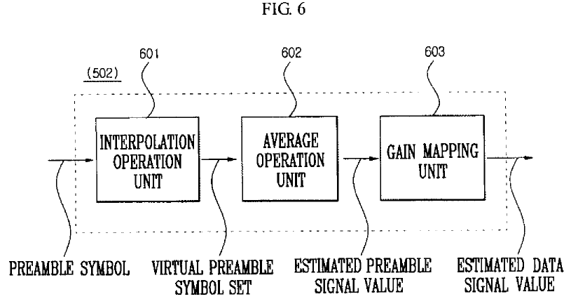

The signal estimation unit 502 estimates preamble signals and data signals from the preamble symbols obtained by the preamble symbol obtaining unit 501. Since the preamble signals and noise and interference component signals are mixed in the preamble symbols obtained by the preamble symbol obtaining unit 501, the signal estimation unit 502 estimates the preamble signals from the preamble symbol and then the noise and interference component signals using the estimated preamble signal value. In addition, the signal estimation unit 502 estimates the data signals on the basis of the estimated preamble signal values. Operation of the signal estimation unit 502 will be described in further detail below with reference to FIG. 6.

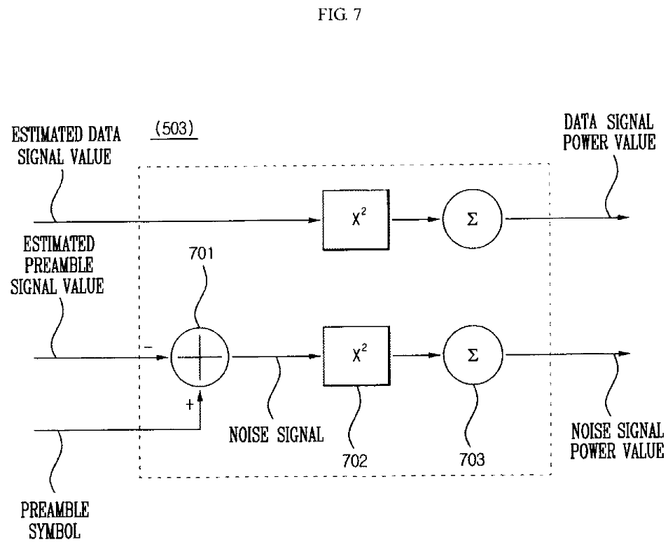

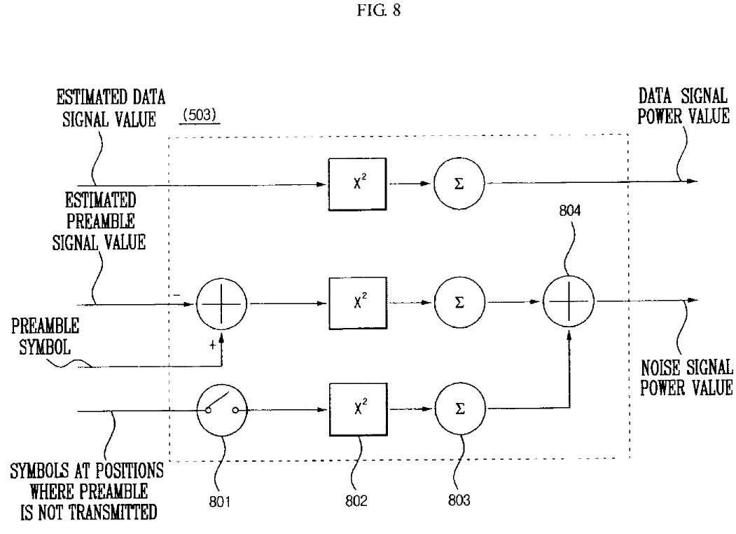

The power calculation unit 503 calculates power values of the data signals estimated by the signal estimation unit 502 and power values of the noise signals using a difference between the preamble symbols obtained by the preamble symbol obtaining unit 501 and the preamble signals estimated by the signal estimation unit 502. In other words, the power calculation unit 503 calculates the power values by squaring the data signals and the noise signals. In addition, with respect to a plurality of preamble symbols, the power calculation unit 503 separately accumulates power values of data signals and noise signals for a predetermined time, thereby further improving the accuracy of CINR calculation. Operation of the power calculation unit 503 will be described in further detail below with reference to FIGS. 7 and 8.

The CINR calculation unit 504 calculates a CINR using the power values of the data signals and the noise signals calculated by the power calculation unit 503. A CINR is defined as total sub-carrier signal power divided by total noise and interference signal power. Therefore, the CINR calculation unit 504 can calculate the CINR by dividing a total power value of the data signals by a total power value of the noise signals.

$$\frac{G \cdot {\sum }_{n = 0}^{N - 1} {\vert \hat{h} ( n ) \vert}^{2}}{{\sum }_{n = 0}^{N - 1} {\vert p ( n ) - \hat{h} ( n ) \vert}^{2}} \qquad ( Formula 1 )$$

Formula 1 expresses the process of calculating a CINR using the power calculation unit 503 and the CINR calculation unit 504. Here,

ĥ
(n) denotes a preamble signal estimated according to the present invention, p(n) denotes a preamble symbol in which preamble signal components are mixed with noise components, N denotes an accumulation parameter of each terminal, and G denotes a parameter for adjusting a signal measured using preamble symbols to the gain of data signals. In other words, N is the number of preamble symbol sub-carriers.

In addition, n denotes a preamble symbol sub-carrier index, and N denotes an index of the maximum preamble carriers that can be included in a DL frame according to power consumption. In case of multiple zones, N denotes the maximum value of the corresponding zone.

According to the present invention, the preamble symbol obtaining unit 501, the signal estimation unit 502, the power calculation unit 503 and the CINR calculation unit 504 perform above-described operations for each logical band, thereby measuring logical band-specific CINRs.

In order to measure a CINR of each logical band, first, preambles may be classified into sub-groups, which correspond to logical band zones in the frequency domain, numbering the same as the logical bands. In other words, FFT-processed preambles are classified into sub-groups corresponding to the logical bands, and the CINR measuring apparatus 402 measures a CINR of each logical band using only preambles included in the corresponding logical band.

In the DL band-AMC channel mode, a logical band fundamentally includes two physical bands, and the number of logical bands is determined according to an FFT size. For example, when the FFT size is 1024, the number of physical bands is 24 and the number of logical bands is 12 in DL band-AMC with 2 bin*3 symbol. Therefore, in this case, the CINR measuring apparatus 402 separately measures CINRs of the 12 logical bands.

More specifically, the preamble symbol obtaining unit 501 extracts preamble symbols from the preambles classified into sub-groups in the frequency domain. The signal estimation unit 502 estimates logical band-specific preamble signals from the preamble symbols using an appropriate scheme or algorithm according to a segment-specific transmission structure as illustrated in FIG. 3, and estimates data signals on the basis of the estimated preamble signals. The power calculation unit 503 calculates power values of logical band-specific data signals estimated by the signal estimation unit 502, and calculates power values of logical band-specific noise signals from differences between the preamble symbols obtained by the preamble symbol obtaining unit 501 and the preamble signals estimated by the signal estimation unit 502. The CINR calculation unit 504 calculates logical band-specific CINRs using the logical band-specific power values of data signals and noise signals.

In addition, according to the present invention, a reference CINR for the measured logical band-specific CINRs is measured using preambles of the whole frequency domain.

The terminology “whole band” refers to an overall FFT size, and “reference CINR” refers to a CINR measured using all preambles in the FFT size.

In this way, a terminal compares the CINR of a currently allocated and used logical band with the reference CINR and thereby can positively require allocating a channel of another logical band or channel mode.

In other words, the CINR measuring apparatus 402 of the present invention further includes the band switching determination unit 505, which determines whether or not to switch to another channel mode or logical band according to the CINRs respectively measured according to the logical bands.

For example, using the CINRs respectively measured according to the logical bands, the band switching determination unit 505 can determine whether or not to switch between a normal channel mode, e.g., DL PUSC, DL FUSC, etc., and the DL band-AMC channel mode, or switch the terminal to a band having better channel quality in the DL band-AMC channel mode.

Alternatively, when the communication terminal aligns the CINRs respectively measured according to the logical bands in decreasing order and reports CINRs numbering the same as required for the currently serving base station to the base station, the base station may determine whether or not to switch to another channel mode or logical band according to the CINRs reported thereto.

FIG. 6 is a block diagram showing a constitution of the signal estimation unit 502 according to an exemplary embodiment of the present invention. As illustrated in FIG. 6, the signal estimation unit 502 includes an interpolation operation unit 601 and an average operation unit 602.

The interpolation operation unit 601 receives preamble symbols and performs an interpolation operation in the frequency domain, thereby generating a predetermined virtual preamble symbol set. According to the present invention, the amount of information, i.e., the number, of the preamble symbols obtained from the preamble symbol obtaining unit 501 is not sufficient for estimating preamble signals or other purposes. Thus, a method is required for estimating the preamble signals more efficiently using the preamble symbols.

According to an example of the method, the interpolation operation unit 601 copies the preamble symbols to increase the number and calculates an intermediate value between the increased preamble symbols by a predetermined interpolation operation, thereby generating the virtual preamble symbol set appropriate for estimating the preamble signals.

Meanwhile, the interpolation operation may use linear interpolation, secondary interpolation, cubic spline interpolation, interpolation with a low-pass filter, etc. The interpolation operation may be appropriately selected according to system requirements and accuracy.

The average operation unit 602 performs an averaging operation on the virtual preamble symbol set generated by the interpolation operation unit 601 in the time domain, thereby estimating the preamble signals. The virtual preamble symbol set includes noise and interference component signals as well as the preamble signals. The noise and interference component signals are kinds of white noise and have a random probability distribution in generation frequency and level. Therefore, when the average operation unit 602 sums up and averages all the preamble symbols included in the virtual preamble symbol set in the time domain, all the noise and interference component signals are suppressed, and only the desired preamble signals can be easily extracted.

The signal estimation unit 502 finally estimates data signals using the preamble signals. In general, a preamble signal is different from a data signal in transmission power according to a channel structure or OFDMA/OFDM symbol structure. Therefore, in order to estimate the data signals from the preamble signals, the gain mapping unit 603 multiplies the estimated preamble signals by an appropriate weight, thereby adjusting the gain.

For example, when the levels of the preamble signals are higher than the levels of the data signals by a predetermined power measured in decibel, the data signals can be estimated by properly mapping the gain to make the preamble signal levels correspond to the data signal levels.

FIG. 7 is a block diagram showing a constitution of the power calculation unit 503 according to an exemplary embodiment of the present invention. As illustrated in FIG. 7, the power calculation unit 503 receives estimated data signal values, estimated preamble signal values and preamble symbols and outputs data signal power values and noise signal power values.

The power calculation unit 503 can extract a noise signal from a difference between a preamble symbol and an estimated preamble signal. More specifically, since the preamble symbol includes a preamble signal and the noise and interference signal, it is possible to extract the noise and interference signal alone by subtracting the estimated preamble signal from the preamble symbol (701). In addition, the power calculation unit 503 performs an accumulation operation (703) on extracted data signals and noise signals for a predetermined time after a squaring operation (702), thereby calculating a data signal power value and a noise signal power value.

FIG. 8 is a block diagram showing a constitution of the power calculation unit 503 when a frequency reuse factor is 1 according to an exemplary embodiment of the present invention.

The frequency reuse factor is a parameter indicating frequency efficiency, which means how many cells an entire frequency band is divided and allocated to. The frequency reuse factor is used in a method of increasing the number of channels per unit area.

In the present invention, different methods may be applied to calculate the power of noise and interference components according to the frequency reuse factor. More specifically, when the frequency reuse factor is not 1, different frequency bands can be used in one cell or sector. Thus, in the structures of FIG. 3, noise and interference components only at positions where a preamble is transmitted should be considered.

On the other hand, when the frequency reuse factor is 1, the same frequency band can be used all over one cell or sector. Thus, in the structures of FIG. 3, symbol values at positions where a preamble is not transmitted include noise and interference components. Therefore, when the frequency reuse factor is 1, noise and interference factors must be considered in CINR calculation. In other words, according to the present invention, when the frequency reuse factor is 1, the power calculation unit 503 further includes power values of symbols other than the preamble symbol in a power value of the noise signal.

As illustrated in FIG. 8, a selector 801 closes or opens a switch according to the frequency reuse factor, thereby performing the operation of adding or excluding symbol values at positions where a preamble is not transmitted as/from noise and interference components.

When the frequency reuse factor is 1, a CINR is calculated by Formula 2 given below.

$$\frac{G \cdot {\sum }_{n = 0}^{N - 1} {\vert \hat{h} ( n ) \vert}^{2}}{{\sum }_{n = 0}^{N - 1} {\vert p ( n ) - \hat{h} ( n ) \vert}^{2} + {\sum }_{m = 0}^{M - 1} {\vert p ( m ) \vert}^{2}} \qquad ( Formula 2 )$$

Here,

ĥ
(n) denotes a preamble signal estimated according to the present invention, p(n) denotes a modulation DL preamble symbol in which preamble signal components are mixed with noise components, and p(m) denotes an un-modulation DL preamble symbol in which noise components are mixed. In addition, n denotes a preamble symbol sub-carrier index, N denotes an index of the maximum preamble carriers that can be included in a DL frame according to power consumption, and M denotes an accumulation parameter. Meanwhile, p(m) excludes a left guard interval, a right guard interval, and a DC sub-carrier. G denotes a parameter for adjusting a signal measured using preamble symbols to the gain of data signals.

When Formula 2 is compared with Formula 1, Formula 2 further includes power values of the signal p(m) indicating symbol values at positions where a preamble is not transmitted in the denominator indicating the total power of noise and interference component signals. That is, when the frequency reuse factor is 1, power values of symbols other than preamble symbols are further included in the total power value of the noise signals.

In this way, according to the present invention, noise and interference component signals are extracted or not depending on the frequency reuse factor, so that a CINR can be measured more accurately.

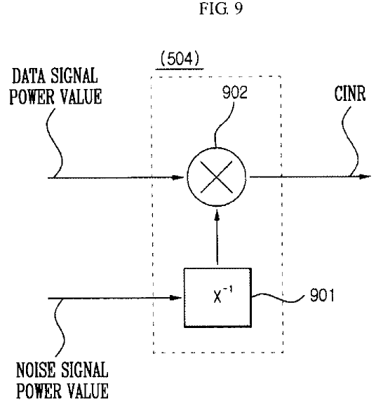

FIG. 9 is a block diagram showing a constitution of the CINR calculation unit 504 according to an exemplary embodiment of the present invention. A carrier signal-to-noise ratio is a ratio of a carrier signal level to a noise level in a signal transmission system. In an OFDM/OFDMA system according to the present invention, a CINR can be measured as an example of the carrier signal-to-noise ratio. The CINR, which is generally expressed in units of dB, is defined as total sub-carrier signal power divided by total noise and interference power, and can be obtained using a power value of a data signal and a power value of a noise signal in the present invention. In the CINR calculation unit 504, in order to calculate a CINR, the reciprocal of a noise signal power value is taken (901) and input to a multiplier (902) together with a data signal power value as illustrated in FIG. 9.

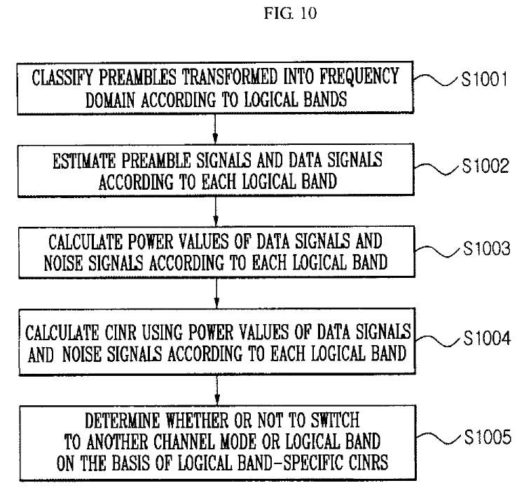

FIG. 10 is a flowchart showing a method of measuring CINRs using preambles according to an exemplary embodiment of the present invention.

In step 1001, preamble symbols transformed into the frequency domain are classified according to a plurality of logical bands. In this step, in order to measure a CINR of each logical band, first, the preambles are classified into sub-groups, which correspond to logical band in the frequency domain, numbering the same as the logical bands. In other words, the FFT-processed preambles are classified into sub-groups corresponding to the logical bands, thereby measuring a CINR of each logical band using only preambles included in the corresponding logical band.

In step 1002, preamble signals and data signals are estimated according to each logical band. In this step, preamble symbols are extracted from preambles in the frequency domain classified into the sub-groups, and preamble signals of each logical band are estimated from the preamble symbols using an appropriate scheme or algorithm for a transmission structure conforming to a segment. In addition, data signals are estimated from the preamble signals.

Step 1002 includes the sub-steps of performing the interpolation operation on preamble symbols of each logical band in the frequency domain to generate a virtual preamble symbol set, and performing the averaging operation on the virtual preamble symbol set in the time domain to estimate preamble signals.

Since the amount of information, i.e., the number, of the preamble symbols is generally not sufficient for estimating preamble signals or other purposes, a method is required for estimating the preamble signals more efficiently using the preamble symbols.

For this reason, in the sub-step of generating a virtual preamble symbol set, the preamble symbols are input, copied and increased, and an intermediate value between the increased preamble symbols is calculated by a predetermined interpolation operation, thereby generating a virtual preamble symbol set appropriate for estimating the preamble signals. The interpolation operation may use linear interpolation, secondary interpolation, cubic spline interpolation, interpolation with a low-pass filter, etc. The interpolation operation may be appropriately selected according to system requirements and accuracy.

In addition, in the sub-step of estimating the preamble signals, the averaging operation is performed on the virtual preamble symbol set in the time domain, thereby estimating the preamble signals. The virtual preamble symbol set includes noise and interference component signals as well as the preamble signals. The noise and interference component signals are kinds of white noise and have a random probability distribution in generation frequency and level. Therefore, in this step, when all preamble symbols included in the virtual preamble symbol set are summed and averaged in the time domain, all the noise and interference component signals are suppressed, and only desired preamble signals can be easily estimated. In addition, in this step, in order to finally estimate data signals using the preamble signals, the estimated preamble signal values are multiplied by an appropriate weight, thereby adjusting the gain. For example, when levels of the preamble signals are higher than levels of the data signals by a predetermined power in units of dB, the data signals can be estimated by properly mapping the gain to make the preamble signal levels correspond to the data signal levels.

In step 1003, power values of the data signals and noise signals are calculated according to the logical bands. More specifically, in this step, power values of the estimated data signals of each logical band are calculated, and power values of noise signals are calculated from the estimated preamble signal values and the preamble symbols obtained in step 1002.

The preamble symbol includes a preamble signal and a noise and interference signal. Thus, the noise and interference signal alone can be extracted by subtracting the estimated preamble signal from the preamble symbol. Furthermore, in this step, the accumulation operation is performed on the data signals and noise signals for a pre-determined time after the squaring operation, thereby calculating the data signal power values and the noise signal power values.

In addition, in this step, symbol values at positions where a preamble is not transmitted may be added or excluded as/from noise and interference components according to a frequency reuse factor, which is a parameter indicating how many cells a whole frequency band is divided and allocated to, i.e., indicating frequency efficiency.

For example, when the frequency reuse factor is 3, a different frequency band may be used in each cell. Thus, in the structures of FIG. 3, only noise and interference components at positions where a preamble is transmitted should be considered. On the other hand, when the frequency reuse factor is 1, the same frequency band can be used in all the cells, and thus symbol values at positions where a preamble is not transmitted also include noise and interference components in the structures of FIG. 3. Therefore, when the frequency reuse factor is 1, the noise and interference components must be considered in CINR calculation. In other words, according to the present invention, when the frequency reuse factor is 1, power values of symbols other than the preamble symbols are further included in the noise signal power values.

In step 1004, a CINR of each logical band is calculated using power values of data signals and noise signals. In other words, since a CINR is defined as total sub-carrier signal power divided by total noise and interference signal power, the CINR can be calculated by dividing a total power value of the data signals by a total power value of the noise signals in this step.

In step 1005, it is determined whether or not to switch to another channel mode or logical band on the basis of the logical band-specific CINRs. For example, in this step, using the CINRs respectively measured according to logical bands, it can be determined whether or not to switch between a normal channel mode, e.g., DL PUSC, DL FUSC, etc., and the DL band-AMC channel mode, or switch a terminal to a band having better channel quality in the DL band-AMC channel mode.

Alternatively, when the communication terminal aligns the CINRs measured according to the logical bands in decreasing order and reports CINRs numbering the same as required for a currently serving base station to the base station, the base station may determine whether or not to switch to another channel mode or logical band according to the CINRs reported thereto.

Alternatively, the step of measuring a reference CINR of the CINRs respectively measured according to logical bands using preambles of the entire frequency domain may be included. In this way, it is possible to positively require allocating a channel of another logical band or channel mode by comparing the reference CINR with the CINR of a currently allocated and used logical band.

In other words, the CINR measuring apparatus 402 further includes the band switching determination unit 505, which determines whether or not to switch to another channel mode or logical band according to the CINRs respectively measured according to the logical bands.

Thus far, the method of measuring CINRs according to a plurality of logical bands using preambles has been described according to an exemplary embodiment of the present invention. Detailed descriptions of embodiments shown in FIGS. 1 to 9 can be applied to this embodiment without modification and thus will not be reiterated here.

The method of measuring CINRs using preambles according to exemplary embodiments of the present invention can be embodied as computer program commands and recorded on computer-readable media. The computer-readable media may include program commands, data files, data structures, etc. separately or compositely. The program commands recorded in the media may be particularly designed and configured for the present invention, or known and used by those skilled in the computer software field. The computer-readable media may be magnetic media such as a hard disk, a floppy disk and magnetic tape, optical media such as a compact disk read-only memory (CD-ROM), and hardware devices such as a ROM, a random-access memory (RAM), a flash memory, etc., particularly implemented to store and execute program commands. Also, the media may be transmission media such as optical or metal lines, waveguides, etc. including carriers delivering signals indicating program commands, data structures, and so on. The program commands may be machine language codes produced by a compiler and high-level language codes that can be executed by computers using an interpreter, etc. In order to perform the operations of the present invention, the hardware devices may be implemented to operate as at least one software module, and vice versa.

While the invention has been shown and described with reference to certain exemplary embodiments thereof, it will be understood by those skilled in the art that various changes in form and details may be made therein without departing from the spirit and scope of the invention as defined by the appended claims.

1. A digital communication system, comprising:
a preamble symbol obtaining unit for obtaining downlink preamble symbols from a baseband frequency signal in a downlink channel mode zone having a plurality of logical bands;
a signal estimation unit for estimating preamble signals and data signals from the preamble symbols;
a power calculation unit for calculating power values of the estimated data signals and power values of noise signals from the preamble symbols and the estimated preamble signals; and
a carrier-to-interference-and-noise ratio (CINR) calculation unit for calculating CINRs associated with the channel mode using the power values of the data signals and the noise signals.

2. The digital communication system of claim 1, wherein the channel mode is band-adaptive modulation and coding (AMC) permutation zone.

3. The digital communication system of claim 1, wherein the preamble symbols are obtained from the whole logical bands in a frequency domain.

4. The digital communication system of claim 1, wherein the preamble symbols are classified into a plurality of groups corresponding to the logical bands in a frequency domain, the signal estimation unit estimates preamble signals and data signals from each classified preamble symbol group, and the CINR calculation unit separately measures CINRs respectively corresponding to the logical bands from the estimated data signals.

5. The digital communication system of claim 4, further comprising:
a CINR reporting unit for selecting a predetermined number of the separately measured CINRs in order of values and transmitting them to a base station.

6. The digital communication system of claim 5, wherein the base station determines whether or not to switch to another channel mode or logical band according to the reported CINRs.

7. The digital communication system of claim 1, wherein the noise signal includes interference signal.

8. The digital communication system of claim 4, further comprising:
a band switching determination unit for determining whether or not to switch to another channel mode or logical band according to the separately measured CINRs.

9. The digital communication system of claim 1, wherein the signal estimation unit comprises:
an interpolation operation unit for performing an interpolation operation on the preamble signals in a frequency domain and generating a virtual preamble symbol set; and
an average operation unit for performing an averaging operation on the virtual preamble symbol set in a time domain and estimating the preamble signals.

10. The digital communication system of claim 1, wherein the signal estimation unit comprises:
a gain mapping unit for adjusting gain of the estimated preamble signals and estimating the data signals.

11. The digital communication system of claim 1, wherein the baseband frequency signal is an orthogonal frequency division multiplexing (OFDM) signal or an orthogonal frequency division multiple access (OFDMA) signal.

12. The digital communication system of claim 1, wherein when a frequency reuse factor is 1, the power calculation unit further comprises power values of symbols at positions where the downlink preamble symbols are not transmitted in the power values of the noise signals.

13. The digital communication system of claim 1, wherein the system is based on at least one of Institute of Electrical and Electronics Engineers (IEEE) 802.16d/e, wireless broadband Internet (WiBro), and worldwide interoperability for microwave access (WiMAX) standards.

14. A digital communication system, comprising:
a preamble symbol obtaining unit for separately obtaining downlink preamble symbols according to a plurality of logical bands from a baseband frequency signal in a downlink channel mode zone having the logical bands;
a signal estimation unit for estimating preamble signals and data signals from the obtained preamble symbols;
a power calculation unit for calculating first power values of the estimated data signals and second power values of interference and noise from the preamble symbols and the estimated preamble signals; and
a CINR calculation unit for separately calculating CINRs according to the logical bands using the first and second power values,
wherein the power calculation unit determines whether or not to add third power values of symbols at positions where the downlink preamble symbols are not transmitted to the second power values according to a frequency reuse factor.

15. A method of measuring CINRs in a downlink channel mode zone having a plurality of logical bands, the method comprising the steps of:
obtaining downlink preamble symbols from a baseband frequency signal;
estimating preamble signals and data signals from the preamble symbols;
calculating power values of the estimated data signals and power values of noise signals from the preamble symbols and the estimated preamble signals; and
calculating CINRs using the power values of the data signals and the noise signals.

16. The method of claim 15, wherein the preamble symbols are obtained from the whole logical bands in a frequency domain.

17. The method of claim 15, wherein the preamble symbols are classified into a plurality of groups corresponding to the logical bands in a frequency domain, the preamble signals are estimated from each classified preamble symbol group in the step of estimating the preamble signals, and the CINRs respectively corresponding to the logical bands are separately measured from the estimated preamble signals in the step of calculating the CINRs.

18. The method of claim 17, further comprising the step of:
determining whether or not to switch to another channel mode or logical band according to the separately measured CINRs.

19. The method of claim 15, wherein the noise signal includes interference signal.

20. A computer-readable recording medium, storing a program implementing the method according to claim 14.
